(19) United States
(12) Patent Application Publication
(10) Pub. No.: US 2022/0187242 A1
(43) Pub. Date: Jun. 16, 2022

(54) IMPROVEMENTS IN OR RELATING TO A METHOD OF SEPARATING AND ANALYSING A COMPONENT

(71) Applicant: Fluidic Analytics Limited, Cambridge (GB)

(72) Inventors: Thomas Mueller, Cambridge (GB); Philipp Hahn, Cambridge (GB); Sean Devenish, Cambridge (GB); Ashish Asthana, Cambridge (GB); Tuomas Pertti Jonathan Knowles, Cambridge (GB)

(73) Assignee: Fluidic Analytics Limited, Cambridge (GB)

(21) Appl. No.: 17/598,204

(22) PCT Filed: Mar. 27, 2020
(86) PCT No.: PCT/GB2020/050833

§ 371 Date: Sep. 24, 2021

(30) Foreign Application Priority Data
Mar. 29, 2019 (GB) 1904376.9

(51) Int. Cl. G01N 27/447

(52) U.S. Cl. CPC G01N 27/44791; G01N 27/44773; G01N 27/44795

(57) ABSTRACT

A method of separating and analysing a plurality of components in a heterogeneous sample is provided. The method comprising the steps of: introducing a separation fluid into a separation channel that is elongate in a first direction; introducing the heterogeneous sample into said channel; separating, in the first direction, the components in the sample; introducing an auxiliary fluid into said channel; creating a lateral distribution of the components in a second direction substantially perpendicular to the first direction; and determining, sequentially, a property of each of the components based on the regimen by which the lateral distribution was created. An apparatus for separating and analysing a plurality of components in a heterogeneous sample is also provided.

The present invention relates to improvements in or relating to a method of separating and analysing a component and in particular, a method of separating and analysing a plurality of components in a heterogeneous sample. The present invention also relates to providing an apparatus for separating and analysing a plurality of components.

Electrokinetic separation techniques, such as capillary zone electrophoresis (CE) capillary gel electrophoresis (CGE), capillary isoelectric focusing (CIEF), capillary isotachophoresis and micellar electrokinetic chromatography (MEKC) are powerful analytical tools commonly used to separate a plurality of components in a sample in solution. Separation of components using CE is based on the electrophoretic mobility of the component and thus CE allows for determination of purity of components in a sample. The separated samples can then be detected optically with either absorption or fluorescence measurements. Alternatively, the separated samples can be determined off chip after collection or injection into a down-stream detection module.

However, there are several drawbacks of using CE at present. Firstly, it lacks positive identification of the species separated. It is known to combine capillary electrophoresis with Taylor dispersion, but this technique loses resolution as dispersion occurs in the same direction as separation and therefore the dispersive broadening of peaks can cause adjacent peaks to combine with a corresponding loss of detail in the identification. Moreover, it is difficult to reproduce experiments using CE due to variations in electro-osmotic flow (EOF).

More recent geometries have been used where an additional stream joins with an electrophoresis capillary to label components post-separation, where there is diffusion of the label and the component into the other stream. However, diffusion within this set up is not controlled and does not require stable flow rates.

Therefore, it is desirable to provide an apparatus and a method for separating a plurality of components in a sample in a controlled and stable manner. Furthermore, it is also highly desirable to improve the resolution of the separated components using CE for reliable analysis of the components.

It is against this background that the present invention has arisen.
According to the present invention there is provided a method of separating and analysing a plurality of components in a heterogeneous sample, the method comprising the steps of:
introducing a separation fluid into a separation channel that is elongate in a first direction;
introducing the heterogeneous sample into said channel;
separating, in the first direction, the components in the sample; introducing an auxiliary fluid into said channel;
creating a lateral distribution of the components in a second direction substantially perpendicular to the first direction; and
determining, sequentially, a property of each of the components based on the regimen by which the lateral distribution was created.

According to another aspect of the invention, there is provided a method of separating and analysing a plurality of components in a heterogeneous sample, the method comprising the steps of: introducing a separation fluid into a separation channel that is elongate in a first direction; introducing the heterogeneous sample into said channel; separating, in the first direction, the components in the sample; creating a lateral distribution of the components in a second direction substantially perpendicular to the first direction; and determining, sequentially, a property of each of the components based on the regimen by which the lateral distribution was created.

Within the context of this invention, a heterogeneous sample is any sample that could include multiple species that could be separated and analysed according to the method described. For example, a sample containing a single chemical species that exists in solution in a variety of states, such as oligomeric states, is a heterogeneous sample within the meaning of this invention. So, a sample of insulin, which exists in solution as a mixture of a monomer, dimer and hexamer would be a heterogeneous sample within the meaning of this invention as the different oligomeric states enable the sample to be separated in the first direction and then analysed sequentially.

Furthermore, the method of the present invention can be used to test an apparently homogeneous sample to verify whether it is actually homogeneous. Any heterogeneity will be highlighted by the method of the present invention, as heterogeneous components within the sample will separate, either in the separation step, or in the creation of the lateral distribution or both. Only the provision of a null result will confirm a truly homogeneous sample.

The component may be a biological and/or chemical entity such as a biomolecule. In some embodiments, the component may be a polypeptide, a polysaccharide or a polynucleotide. In some embodiments, the component may be a peptide, a protein, an antibody or an antibody fragment thereof. In some embodiments, the component may be DNA, RNA or mRNA or any other forms of nucleotides.

In some embodiments, the separation fluid and the sample may be introduced into the channel via bulk movement of fluids and, once this has occurred, bulk movement of the fluids may cease. In some embodiments, the sample can be introduced into the channel without any bulk movement of fluid. Once a regimen has been established that lacks bulk flow, the separation of components within the fluid can then occur either as a result of one or more fields applied to the channel or hydrodynamically, or via diffusion. This separation arises from molecules, particles or other components within the fluid moving relative to one another as a result of intrinsic properties such as their size or charge. Deployment of diffusive separation is most appropriate in circumstances where there is a considerable difference in size between the species as this will ensure sufficient resolution.

Conversely, the method may be practised under constant flow conditions, i.e. where there is a constant flow of separation fluid and sample into the channel. The bulk fluid flow, in the first direction, will be superposed onto the separation of the components within the sample by diffusion or electrophoresis if an electric field is applied.

The separation fluid may comprise a single species or it may comprise a plurality of different species in order to control the pH of, or set up a pH gradient within, the separation channel. The separation fluid may be referred to as a mobile phase. It may be a liquid and the separation and associated distribution may take place in free solution. Alternatively, whilst the separation fluid may be a liquid, separation may take place in a stationary phase such as a gel or matrix. Alternatively or additionally, the separation and associated distribution may take place with the one or more species in their native state. Alternatively or additionally, the separation and associated distribution may take place with the one or more species in their denatured state.

In some embodiments, the method may further comprise the step of applying an electric field in the first direction. The provision of an electric field enables the separation of the components in the first direction by electrophoresis

In some embodiments, the lateral distribution can be created by diffusion and the property determined is the diffusion coefficient of the each of the components.

In some embodiments, the lateral distribution can be created electrophoretically through the application of an electric field in the second direction and then the property determined may be the electrophoretic mobility of each of the components.

From the mobility it may be possible to calculate the charge provided the size of the component is known as the mobility can be directly proportional to the ratio of the charge and the radius.

In some embodiments, the method may further comprise introducing an auxiliary fluid prior to creating the lateral distribution. In some embodiments, the auxiliary fluid can be the same as the separation fluid.

The auxiliary fluid may be provided as a non-turbulent fluid flow. In some embodiments, the auxiliary fluid is a blank fluid flow. The auxiliary fluid may have a matched flow profile to the sample fluid flow. In particular, the auxiliary fluid may be selected to have similar viscosity and be introduced at a similar flow velocity to the sample fluid flow. In some embodiments, the sample fluid flow and the auxiliary fluid flow come into contact at the end of the separation channel to form a laminar fluid flow entering the distribution channel. Moreover, the auxiliary fluid flows in the same direction as the sample fluid flow in the distribution channel. The flow rate within the auxiliary fluid may be constant.

The provision of the auxiliary fluid enables the sample to create the lateral distribution via the movement of the sample components from the separation fluid into the auxiliary fluid, for instance via electrophoretic or diffusive motion, which can be simpler to do than create an initial profile along the second direction inside the separation channel without auxiliary fluid.

In some embodiments, the auxiliary fluid may be a different pH from the separation fluid.

Depending on the structure in which the method takes place a two-pH step change distribution may be created, where the auxiliary fluid has a different pH from the separation fluid.

Alternatively, where the structure enables more than one auxiliary fluid to be introduced a continuous pH distribution may be created. This creates a pH gradient within the region in which the lateral distribution will be created. As a result, the components within the sample will migrate to a location in which their charge is neutral. A more differentiated lateral distribution is capable of differentiating between a larger number of different components.

In some embodiments, the property determined can be the isoelectric point of each of the components.

In some embodiments, the lateral distribution can be created diffusophoretically. This may result from establishing a large concentration gradient of salts via differential diffusion of anions and cations, which in turn leads to the generation of an electric field in which the sample migrates.

In some embodiments, the lateral distribution can be created thermophoretically. This can be achieved by the provision of heat, possibly via an external heater, to the channel.

In some embodiments, separating of the components in the sample can be achieved using capillary electrophoresis.

In some embodiments, the lateral distribution can be determined via optical detection, such as fluorescence or scattering-based detection.

In some embodiments, the lateral distribution can be determined via single molecule detection. This means each molecule is detected as an individual component, allowing for (digital) counting of molecules.

In some embodiments, separating of the components in the sample can be achieved hydrodynamically.

In some embodiments, the flow velocity of the separation and/or the auxiliary fluids can be measured by a flow sensor. This is advantageous because the electro-osmotic flow velocity can be measured and in turn, the analyte mobility can be determined more accurately.

In some embodiments, the voltage of the electric field applied in the first direction may be substantially constant. In some embodiments, the voltage of the electric field applied in the first direction may decrease with time. This is advantageous since the particles that enter the detection area first will have the highest mobility, meaning that are likely small, so need a shorter residence time in the distribution channel

In some embodiments, the voltage of the electric field applied in the first direction may increase with time. The increase of the voltage over time has the potential to reduce the overall run time required because it will accelerate the slowest moving components.

Alternatively, the electric field may remain constant throughout, at the highest level available and acceptable to achieve differentiation of the components.

In some embodiments, the method of the present invention may further comprise the step of introducing a reference sample to verify the stability of the flow. This reference sample may be introduced in the sample itself. Alternatively, if available, the reference sample may be introduced via the auxiliary fluid,

In some embodiments, the method of the present invention may further comprise the step of determining the concentration of at least one of the components in the sample.

In some embodiments, the method of the present invention may further comprise the step of determining the concentration of each of the components in the sample.

The determination of concentration may be carried out by any standard method of determining concentration, for example protein concentration. It may be an optical method, including fluorescence, chemiluminescence or absorption. Alternatively, it may be an electrical technique, such as conductivity measurements or electrochemical measurements.

In some embodiments, the force that generates the separation in the first direction may also be responsible for the movement of the components through the distribution channel. There may be no other extrinsic or motive force except for that which creates the separation along the first direction. Therefore, the separation is created by capillary electrophoresis and the lateral distribution is being created by diffusion.

In some embodiments, the time-dependent measurement of the property determined via analysing the distribution in the second direction may be used to determine whether a peak contains multiple species.

The longitudinal separation described above separates components into peaks according to a first property, for example electrophoretic mobility. If two components have a very similar value of the first property, they will not be separated properly. So, two components with similar electrophoretic mobility may appear as part of the same peak. By monitoring the second property such as, for example the monitoring of diffusion coefficient or size via lateral distribution along the peak it is possible to determine whether a peak consists of a single species or multiple species. If the peak consists of a single species, only a single size will be found in the lateral distribution.

Conversely, if multiple species with substantially the same electrophoretic mobility are grouped within the peak then the lateral distribution will show multiple sizes. For instance, if the size reading starts at 5 nm and then increases to 8 nm it would signify that within the peak there are at least two species, likely the one with the slightly higher mobility being 5 nm, the slightly slower one being 8 nm in size.

Similarly, if the particles have exactly the same mobility, their centres of longitudinal distribution overlap, but the smaller particle has a more extended longitudinal distribution. That means in the example of 5 nm and 8 nm large species having exactly the same mobility, the first 5 nm would be recorded first, then a mixture between 5 and 8 nm, then 5 nm again.

In another aspect of the present invention, there is provided an apparatus for separating and analysing a plurality of components in a heterogeneous sample, the apparatus comprising: a separation channel elongate in a first direction; a distribution channel configured to enable a lateral distribution of the components to be formed in a second direction substantially perpendicular to the first direction and a property of each of the components to be determined based on the regimen by which the lateral distribution was created; an electrode upstream of the separation channel and an electrode downstream of the distribution channel, configured to apply an electric field in the first direction.

The provision of an electric field in the first direction will enable separation of the components in the separation channel to occur by capillary electrophoresis in the first direction.

In some embodiments, the separation channel has walls to which a surfactant is applied. The application of surfactant to the walls of the channel may suppress electro-osmotic effects and enable electrophoretic effects to predominate. Alternatively, the application of a surfactant to the walls of the channel may enhance electro-osmotic effects to decrease run time or allow for motion of oppositely charged particles in the same direction.

In some embodiments, the distribution channel can be a T-sensor. In some embodiments, the distribution channel, together with the separation channel and an auxiliary channel may form an H-filter with extended inlets. In the context of this specification, the term T-sensor is used to describe a distribution channel with exactly two inlets and the term H-filter is a distribution channel with exactly two inlets and exactly two outlets. Although some T-sensors and H-filters have 180° between their inlets this is not essential.

In some embodiments, there are exactly two inlets to the apparatus. In some embodiments, two auxiliary channels may be provided one on either side of the sample channel to isolate the sample from the walls of the distribution channel.

In some embodiments, the separation channel and the auxiliary channel may be of equal length. In some embodiments, the separation channel and the auxiliary channel may be of equal cross sectional area.

Having the separation channel and the auxiliary channel of equal dimensions simplifies the control of the electro-osmotic and/or electrophoretic flow through the device as the same voltage can be applied across both channels, thereby providing substantially equal electro-osmotic flow rates in the two channels.

Conversely, if packaging of the device demands that the auxiliary channel is shorter than the separation channel, then this can be accommodated, but the potential difference applied to the separation channel and auxiliary channel will be different from one another in order to achieve substantially equal flow.

In some embodiments, the distribution channel may have a cross-sectional area that is the sum of the cross sections of the separation and auxiliary channels.

In some embodiments, the separation channel may be co-linear with the distribution channel.

This configuration, where the separation channel is straight and meets with the central part of the H-filter without any bend or other impedance to flow, is advantageous because it avoids the longitudinal spreading of the sample as a result of different path lengths of components according to their position across the channel width which is observed when the separation channel enters the H-filter in a curved or angled path.

In some embodiments, the auxiliary channel may have a curved form and may be configured to join co-linearly with the separation channel. Alternatively, in some embodiments a straight channel may be provided that joins at an acute angle with the separation channel.

The curved shape of the auxiliary channel enables it to join co-linearly whilst having an independent route from the separation channel. The curve may be a 180° curve, or a semi-circle when viewed in plain view, in order to enable the auxiliary channel to flow from the opposite end of the apparatus from the separation channel.

In some embodiments, the distribution channel may have a width of less than 150 μm. The width of the distribution channel is small in order to avoid electro-kinetic instabilities. In this context, standard channels may be construed to have widths up to 300 μm. In contrast, the small channels may have a width of less than 150 μm, less than 50 μm, less than 25 μm or even less than 10 μm. In some embodiments, the small channels may have a width of more than 10 μm, 25 μm, 50 μm or 75 μm.

In some embodiments, the distribution channel may have a height that is less than its width. The height of the distribution channel is less than the width in order to minimise the deleterious effects of electro-kinetic instabilities. The height may be less than 150 μm, 100 μm, 50 μm, less than 20 μm or even less than 5 μm. In some embodiments, the height may be more than 5 μm, 20 μm, 50 μm or 75 μm.

In some embodiments, the height of the distribution channel can be equal to that of the separation channel and the auxiliary channel and the width of the distribution channel can be the sum of the widths of the separation channel and the auxiliary channel.

In some embodiments, the separation channel may have two outlets which are separated by an acute angle. The outlets are less than 90°, for example 80°, 75° or 60° and these low angles are selected in order to control dispersion of the sample at the outlet of the H-filter.

Alternatively or additionally, the two outlets may be separated by curving at least one channel away from the other.

Alternatively, there may be additional outlets, for example, three, four, five, or ten outlets. The provision of multiple outlets enables the lateral distribution to be binned into a discrete number of segments, each of which can then be analysed separately. If more outlets are provided the binning of the fluid will have a finer granularity and the spread of components present within a single outlet will be minimised.

In some embodiments, the apparatus of the present invention may further comprise an electric field in the first direction over the auxiliary channel. In some embodiments, the electric field in the auxiliary channel may have the same polarity as the electric field in the separation channel.

In some embodiments, the apparatus of the present invention may further comprise flow sensors to determine the bulk flow rate.

In some embodiments, the apparatus of the present invention may further comprise a detection zone downstream of the distribution channel in which the amount of each of the separated components is quantified.

In some embodiments, the apparatus of the present invention may further comprise a labelling zone, downstream of the distribution channel and upstream of a detection zone in which one or more components are labelled.

The label may be used to determine the quantity of one or more of the components within the sample. Alternatively, the determination of the quantity of one or more of the components within the sample may be a label free technique which may take place downstream of the distribution channel.

The invention will now be further and more particularly described, by way of example only, and with reference to the accompanying drawings, in which:

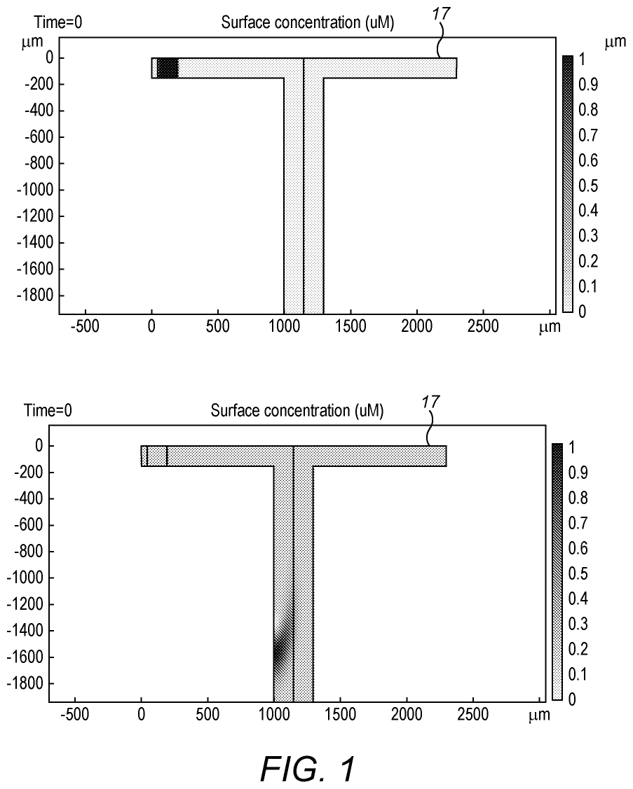

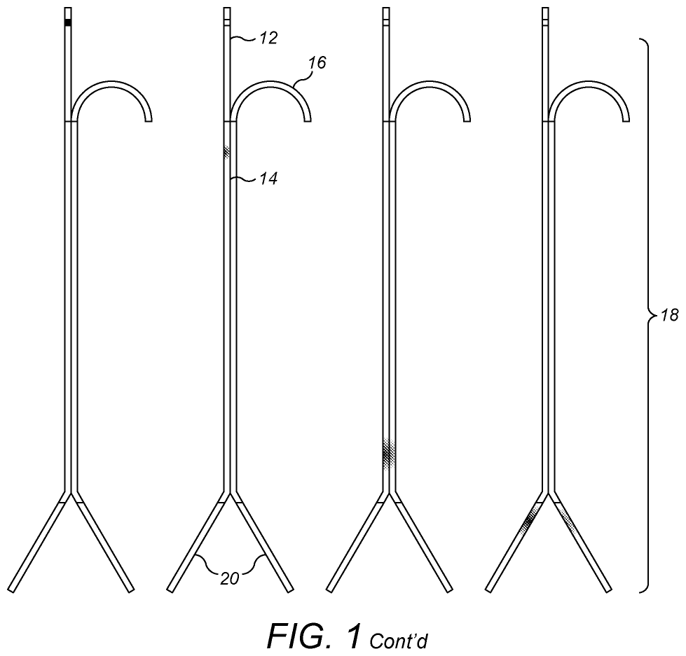

FIG. 1 shows COMSOL simulations of classical and modified geometries according to the present invention;

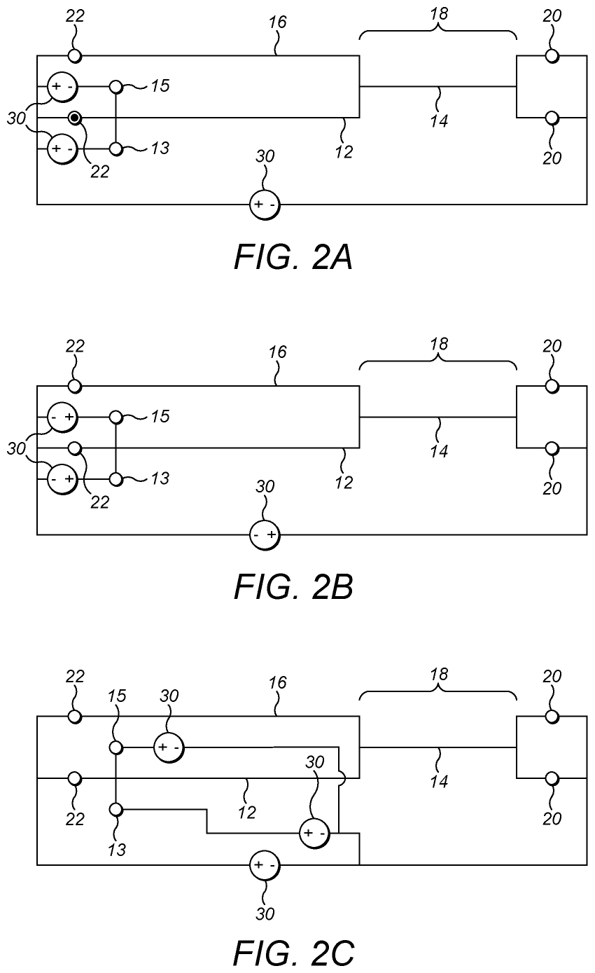

FIGS. 2A, 2B and 2C provide illustrations of exemplary devices according to the present invention with different electrical configurations;

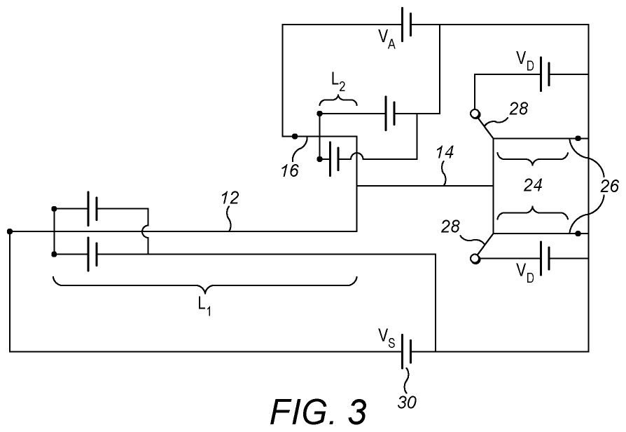

FIG. 3 provides an illustration of the device according to FIGS. 2A to 2C with different length of channels, inlets and outlets;

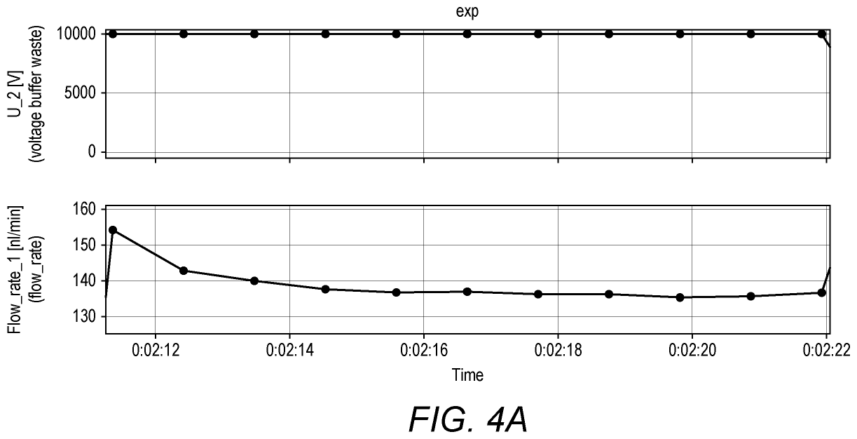

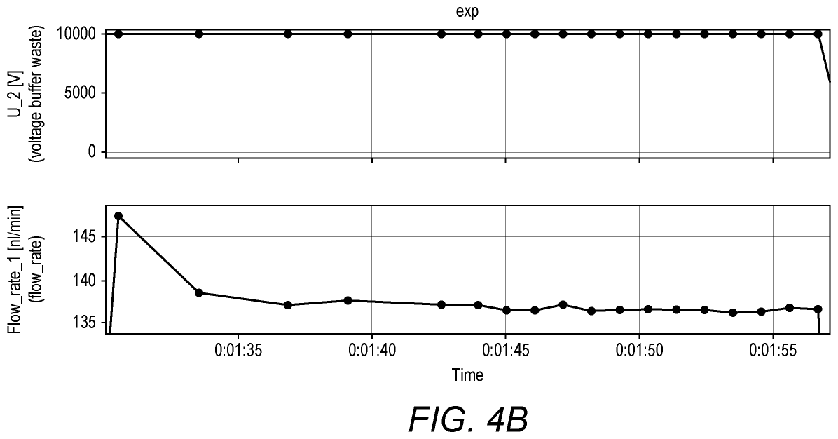

FIGS. 4A and 4B are graphs showing the flow rates during injection at −10 kV, with FIG. 4A showing the start of the experimental series and FIG. 4B showing the end of the experimental series;

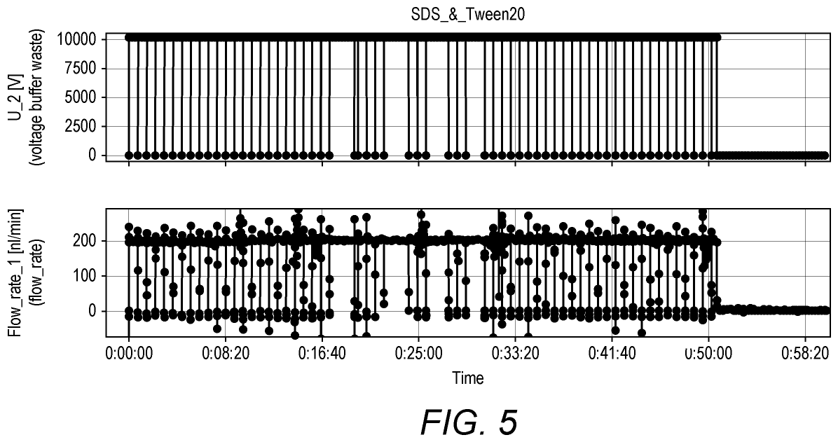

FIG. 5 shows the flow rate during an experiment with multiple cycles of injection and separation of a sample;

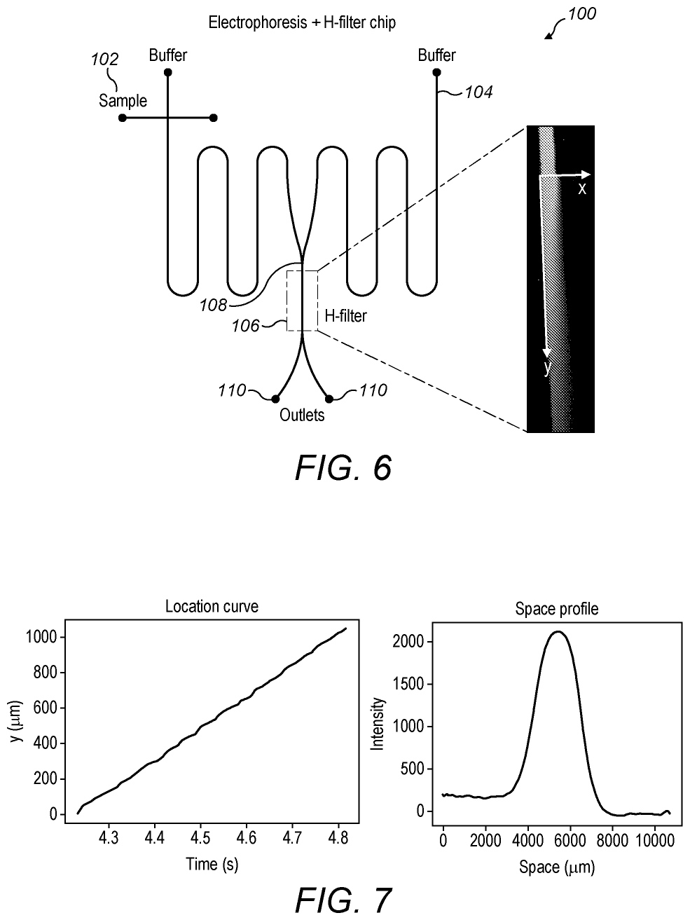

FIG. 6 shows a schematic of a combined electrophoresis-diffusive sizing chip with a detailed view of the H-filter;

FIG. 7 shows a velocity evaluation of the fluorescein plug inside the H-filter after 20 cm of separation channel driven at 10 kV;

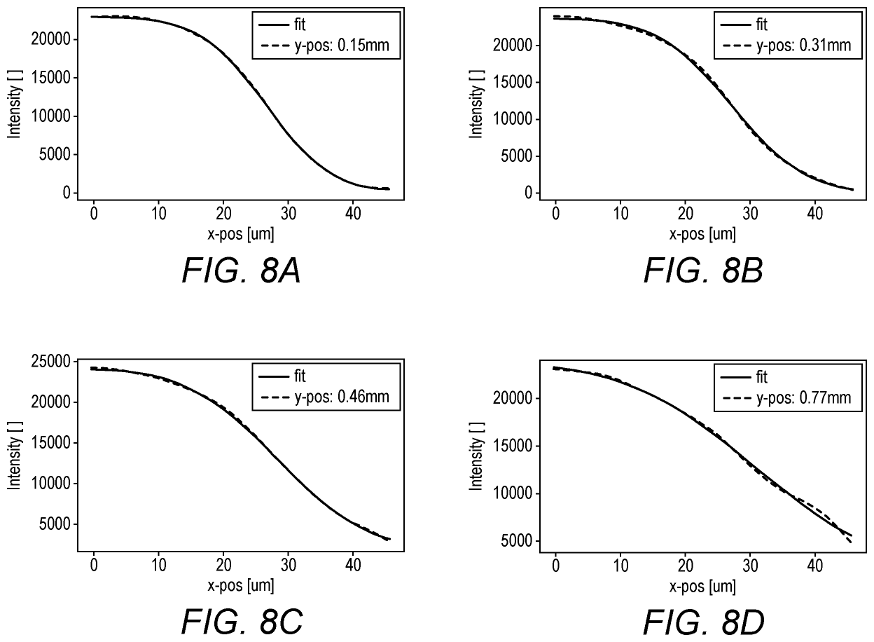

FIGS. 8A to 8D show the intensity profile of fluorescein across the width of the H-filter for different positions along the channel;

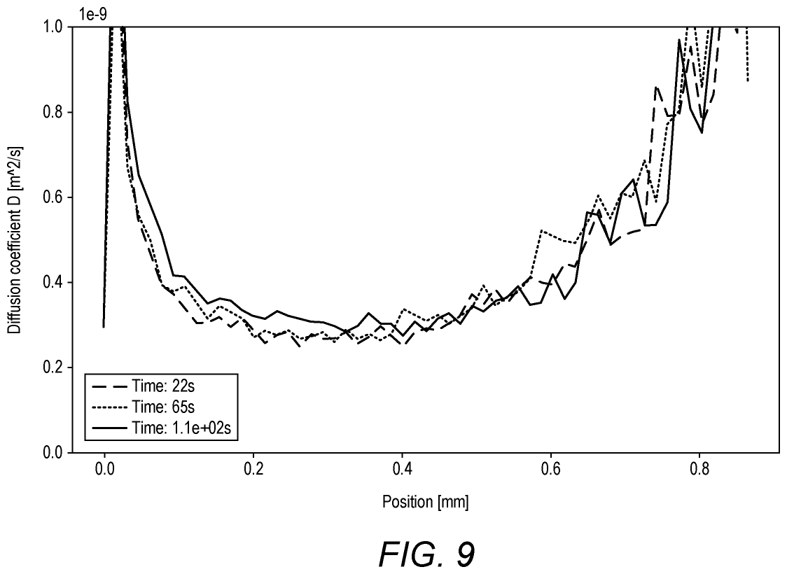

FIG. 9 is a graph of diffusion coefficient of fluorescein in Hepes buffer over position along the H-filter;

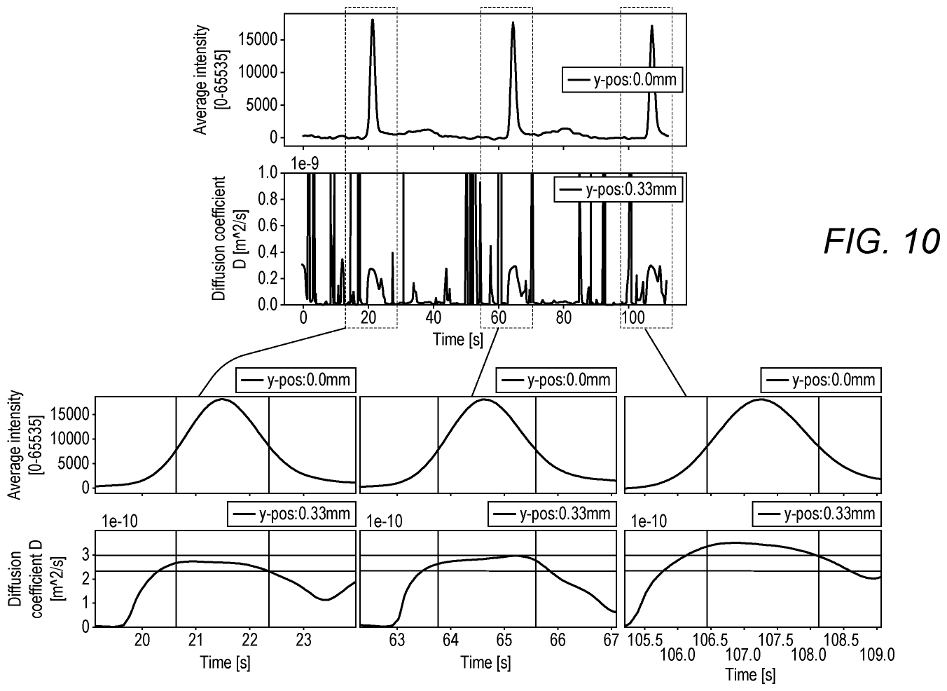

FIG. 10 is a series of corresponding graphs showing the measured diffusion coefficient over time;

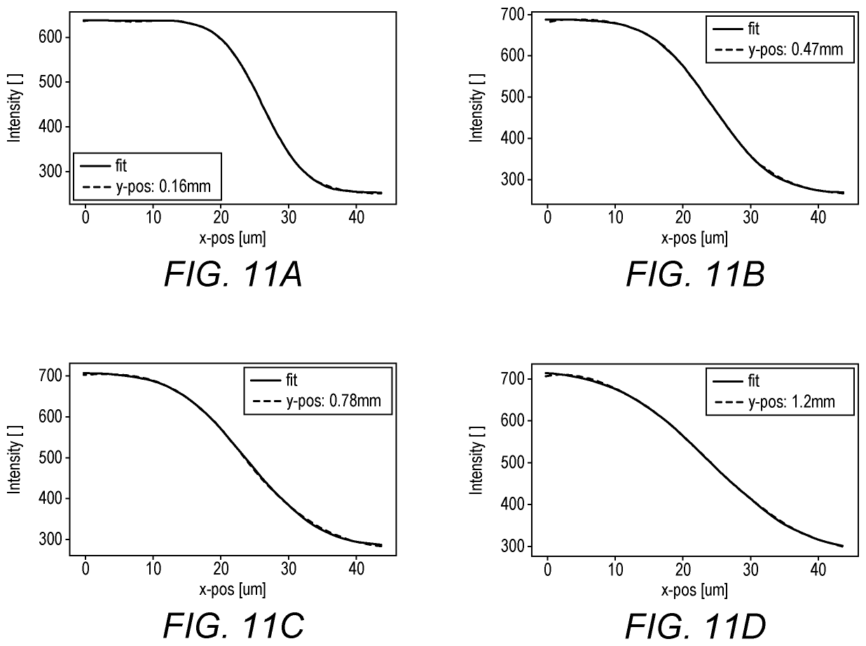

FIGS. 11A to 11D are schematic representations of the intensity profile of BSA across the x-position in the width direction of the H-filter for different y-positions in the flow direction of the channel;

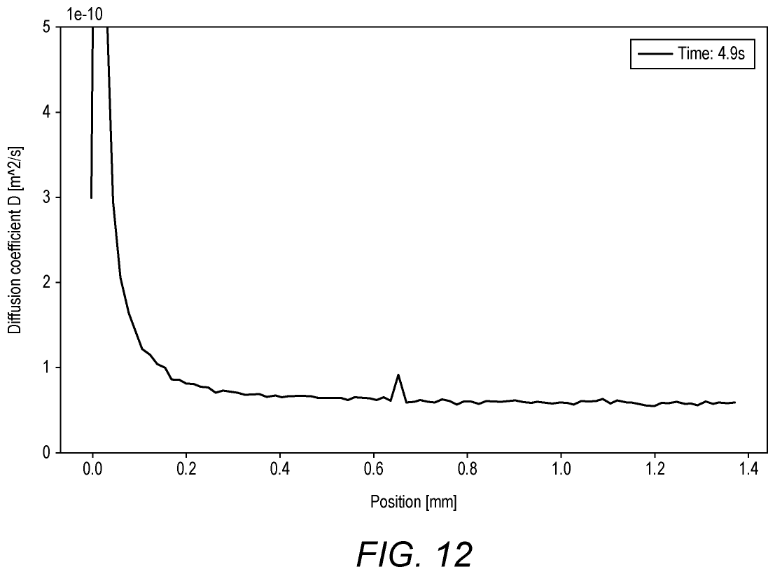

FIG. 12 is a graph of diffusion coefficient of BSA in Hepes buffer over position along the H-filter;

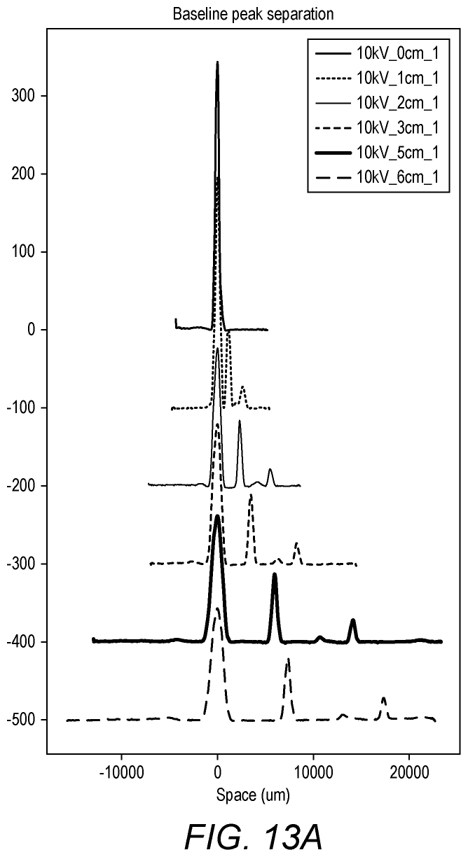

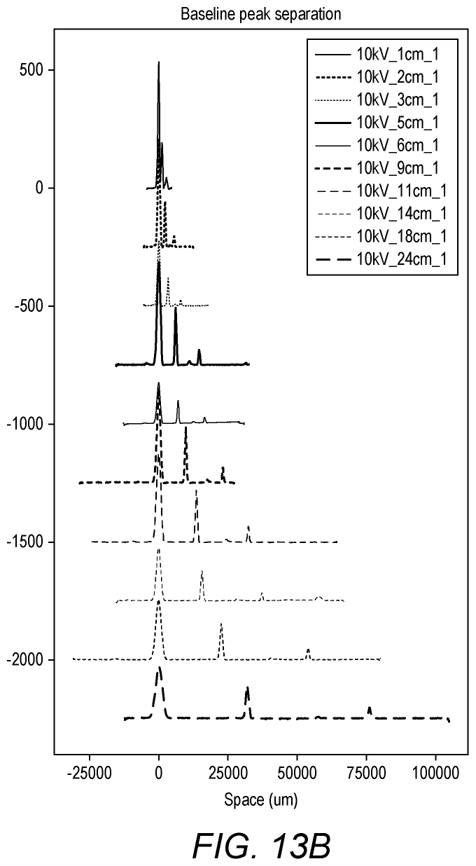

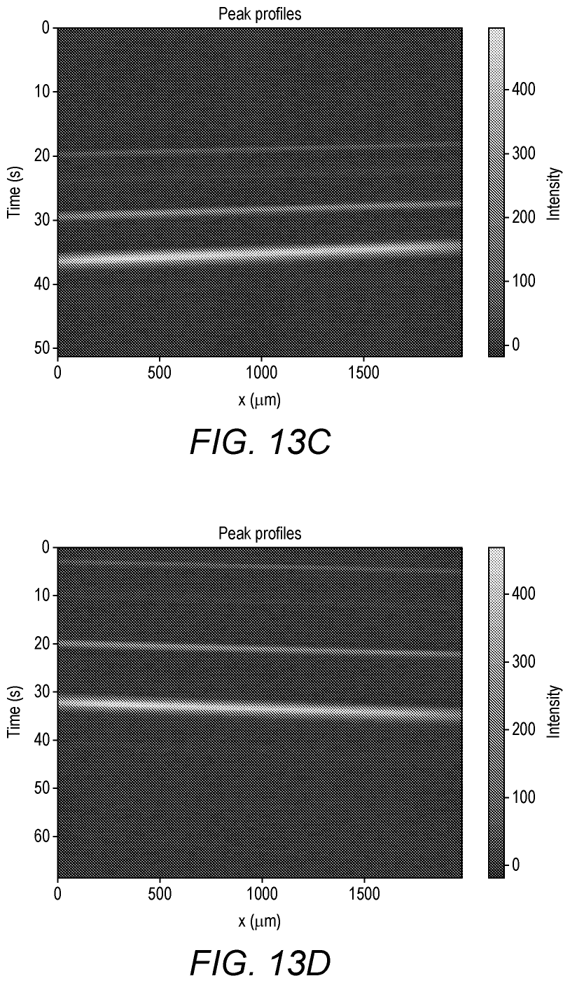

FIGS. 13A and 13B show baseline separation over time to illustrate the time at which the various species detected in the sample can be resolved one from the other;

FIGS. 13C and 13D are the peak profiles that correspond to the baseline peak separation graphs of FIGS. 13A and 13B;

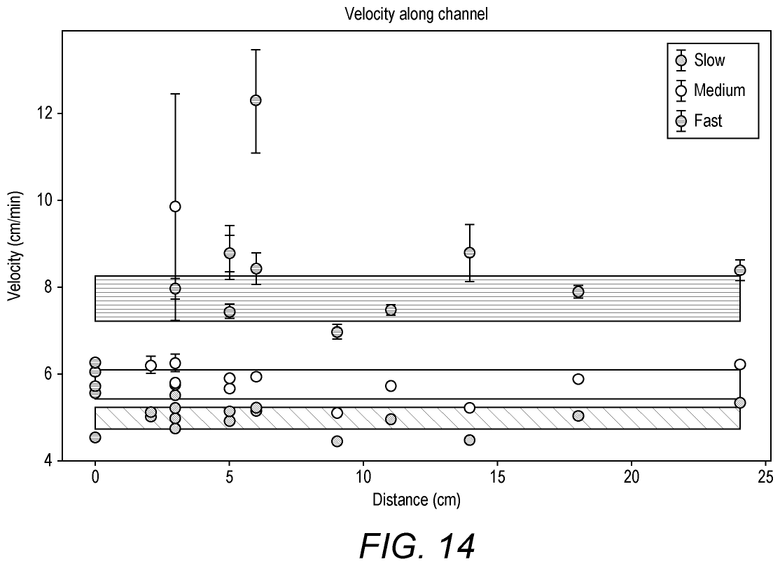

FIG. 14 is a schematic illustration of peak characterisation whereby the data from four measurement series are merged so that the three distinct peaks with the highest intensities may be plotted based on their relative velocities;

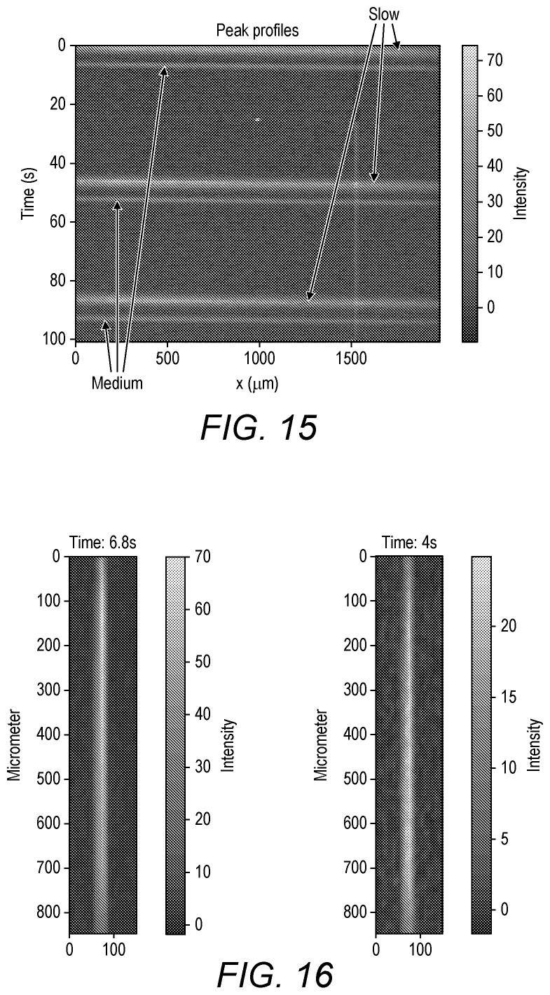

FIG. 15 shows the peak profiles from several consecutive injections illustrating how the procedure can be used to evaluation the data to determine the diffusion coefficient and radius of the detected species; and

FIGS. 16A and 16B show analysis of the slow and medium peaks thereby enabling the monitoring of diffusive spreading as a function of distance from the entrance of the auxiliary fluid.

Referring to FIG. 1, there is provided an apparatus 10 for separating and analysing a plurality of components in a heterogeneous sample. As shown in FIG. 1, the apparatus comprises a separation channel 12 elongate in a first direction; a distribution channel 14 configured to enable a lateral distribution of the components to be formed in a second direction substantially perpendicular to the first direction and a property of each of the components to be determined based on the regimen by which the lateral distribution was created. The distribution channel 14 can be a T-sensor 17 or an H-filter 18. The T-sensor can have any geometry, shape and/or size that make it suitable to act as a distribution channel 14. The general term “T-sensor” may also refer to a Y-sensor and/or filleted sensor. Both the Y sensor and the filleted sensor are suitable to fulfil the same function as the T-sensor.

An adaptation of the H-filter 18 geometry is shown in FIG. 1. The distribution channel 14, together with the separation channel 12 and an auxiliary channel 16 can form the H-filter 18 with extended inlets. In addition, the H-filter 18 has two outlets 20, which are separated by an acute angle. The separated components may flow in the direction towards the outlets 20 of the H-filter 18.

The separation channel 12 runs in parallel to the distribution channel 14 which may reduce the distortion to the concentration profile of the component compared to a separation channel that runs at an angle to the distribution channel. The auxiliary channel 16 has a curved form and can be configured to join co-linearly with the separation channel 12. The curved shape of the auxiliary channel 16 may enable it to join co-linearly whilst having an independent route from the separation channel 12. The curve may be substantially 180° curve, or a semi-circle when viewed in plain view, in order to enable the auxiliary channel 16 to flow from the opposite end of the apparatus from the separation channel 12. The curved shape of the auxiliary channel 16 under electro-osmotic flow should not introduce additional distortion to the concentration profile of the component.

An electrode may be provided upstream of the separation channel 12 and/or an electrode may be provided downstream of the distribution channel 14. The electrode can be configured to apply an electric field in the first direction. Alternatively, the electric field may be applied opposite to the first direction. The electrode may be made of metal such as platinum, gold or silver. The electrode may be made of a semiconductor such as carbon or graphene. Further electrodes may be positioned at the sample port 13 and sample waste port 15, as well as upstream of the auxiliary channel 16 or at the labelling inlets (not shown).

The two outlets 20 at one end of the H-filter 18 can be separated by an acute angle or at an angle less than 90, 80, 70, 60 or 50 degrees. In some instances, a low angle splitting at the outlet 20 of the H-filter 18 could be used to control dispersion of the sample. In some embodiments, not shown in the accompanying drawings, multiple outlets 20 are provided that enable the lateral distribution to be binned into a discrete number of segments, each of which can then be analysed separately.

As illustrated in FIG. 1, there is provided a method of separating and analysing a plurality of components in a heterogeneous sample. The method comprises the step of introducing a separation fluid into a separation channel 12 that is elongate in a first direction; introducing the heterogeneous sample into the separation channel 12; separating, in the first direction, the components in the sample; creating a lateral distribution of the components in a second direction substantially perpendicular to the first direction; and determining, sequentially, a property of each of the components based on the regimen by which the lateral distribution was created.

Separating the components in the separation channel can be achieved by capillary electrophoresis. In addition, the lateral distribution can be created diffusively, electrophoretically, diffusophoretically or thermophoretically.

Referring to FIGS. 2A, 2B, 2C and 3, there is provided an apparatus for separating and analysing samples in a fluid using capillary electrophoresis (CE) separation and diffusive sizing. As shown in FIGS. 2A, 2B and 2C, the apparatus 10 comprises an H-Filter 18 with one or more extended inlets 22. Loading of the sample takes place through a sample port 13 into the separation channel 12 and is either achieved via electro-osmotic flow (EOF) or it is pressure-driven. Once the sample has reached the separation channel 12, an electric field is applied across both ends i.e. inlets 22 and outlets 20 of the H-filter 18 to drive the entire distribution channel 14 electro-osmotically. In order to provide control over the sample being supplied to the separation channel 12 there is a sample waste port 15 corresponding to the sample inlet port 13.

As shown in each of FIGS. 2A, 2B and 2C, there is provided at least one power source 30 so that a voltage can be applied to the separation channel 12 and the auxiliary channel 16. FIGS. 2A, 2B, and 2C show exemplary configurations for the voltage supplies 30 and electric connections that can be used to run the apparatus 10 of the present invention. FIGS. 2A and 2B have the electric field running in the opposite direction as the polarisation is inverted in FIG. 2B relative to the polarisation shown in FIG. 2A. The appropriate selection between the embodiments in FIGS. 2A and 2B will depend on the charge on the components in the sample.

In the embodiment illustrated in each of FIGS. 2A, 2B and 2C, the separation channel 12 and the auxiliary channel 16 are of equal length. The separation channel 12 and the auxiliary channel 16 also have equal cross sectional area. Having the separation channel and the auxiliary channel of equal dimensions simplifies the control of the electro-osmotic flow through the device as the same voltage can be applied across both the separation channel 12 and the auxiliary channel 16, thereby providing substantially equal electro-osmotic flow rates in the separation channel 12 and the auxiliary channel 16.

Moreover, the symmetry between the auxiliary channel 16 and the separation channel 12 ensures equal flow entering the distribution channel 14 and/or throughout the whole H-filter 18. Flow sensors or reference samples (not shown in the accompanied Figures) can be included to determine the bulk flow rate. Reference samples can be introduced into either the separation channel or the auxiliary channel.

Furthermore, the sample can be separated via CE in the separation channel 12 and then can be subjected to diffusive sizing in the H-filter 18. The symmetry the separation channel 12 and the auxiliary channel 16, as well as the constant applied electric field across both channels may provide well-defined flow rates. In some embodiments, the auxiliary capillary may also contain a cross-channel (not shown in the accompanied Figures) for sample loading to enhance symmetry.

Referring to FIG. 3, there is provided a generic device with an H-filter, a labelling zone 24 and a detection zone 26. As shown in FIG. 3, there is a separation channel 12, an auxiliary channel 16 and a distribution channel 14. The distribution channel 14, together with the separation channel 12 and an auxiliary channel 16 forms the H-filter. One or more labelling channels 28 are provided downstream from the H-filter. The labelling channel 28 may contain a dye or label, such as a fluorescence dye, which can be introduced into a labelling zone 24 in which one or more separated components are labelled. In some embodiments, there may be a single label provided from the labelling channels 28. In some embodiments, there may be a plurality of different labels provided from the labelling channels 28. The label may be used to determine the quantity of one or more of the components within the sample.

As shown in FIG. 3, the labelling zone 24, in which one or more components are labelled, is downstream of the distribution channel 14 and upstream of a detection zone 26.

Referring to FIG. 3, there is provided a power supply 30 so that a voltage can be applied to the labelling channel 28, labelling zone 24 and/or the detection zone 26. In some instances, the voltage applied to the labelling channel 28, labelling zone 24 and/or the detection zone 26 may be different from the voltage applied across both the separation channel 12 and the auxiliary channel 16. In some embodiments, the voltage applied to the labelling channel 28, labelling zone 24 and/or the detection zone 26 is equal to the voltage applied across both the separation channel 12 and the auxiliary channel 16. In some embodiments the polarity of the power supply may be opposite to the one shown in FIG. 3.

The detection zone 26 downstream of the distribution channel 14, as shown in FIG. 3, is provided so that the amount of each of the separated components can be quantified.

The apparatus 10 may be provided as a single piece incorporating all of the integers described above together with suitable detection optics and signal processing capabilities to fully process and analyse the sample. However, this approach requires very thorough treatment of the channels between samples. Therefore, in an alternative embodiment, the apparatus 10 may be formed from two distinct parts: a permanent analysis unit and a disposable cartridge. The permanent analysis unit will include the source of the fields applied, the detection optics and processing capacity for analysing the data. The disposable cartridge includes the sample inlet port, separation channel, auxiliary channel and distribution channel. The electrodes may be provided on either the disposable cartridge or on the permanent analysis unit. The two-part approach is optimal when the sample to be analysed is a biological sample as the risk of cross contamination between samples is considerably reduced by the provision of a disposable cartridge. The disposable cartridge may be single use, or at least it may be used with a single sample, which may be subject to one or more separate analyses.

Capillary Electrophoresis Resolution

In some embodiments, the separation may be effected by capillary electrophoresis. A mobility resolution within the range of 1×10⁻¹¹−1×10⁻⁸ m²/V·s, for example 3×10⁻¹⁰ m²/V·s, may be achieved at a channel length of 9 cm. The term mobility resolution is generally referred to the difference in mobility between two particles to give a resolution of 1 (peak separation=2*σ₁+2*σ₂ with σ₁ and σ₂ the widths of peak 1 or 2, respectively).

Resolution Calculation

A peak capacity equation can be used as shown below:

$$n = \frac{{t}_{e l u t i o n}}{4 σ} \qquad ( 1 )$$

n represents peak capacity, i.e. the number of peaks one can fit into the expected elution time assuming all have the same width sigma. tₑₗᵤₜᵢₒₙ represents elution time, i.e. the time it takes a peak to travel from the injection point to the detector sigma: peak width (FWHM) in units of time.

Mobility resolution is defined as the minimum difference in mobility between two analytes required to achieve resolution of one, with resolution defined as:

$$R = \frac{Δ t}{4 σ} = n \frac{Δ {μ}_{a}}{{\overline{μ}}_{a}} \qquad ( 2 )$$

R: resolution between two peaks, i.e. how many peaks one can fit between the differences in elution time At of two peaks

Δμₐ represents the differences in apparent mobility between the two peaks. Apparent mobility is the sum of sample and electro-osmotic flow mobility

μ̅ₐ represents the average apparent mobility

Then the minimum mobility difference needed to achieve resolution of one equals to:

$$Δ {μ}_{a}^{R = 1} = \frac{Δ {μ}_{a}}{R} = \frac{Δ {μ}_{a}}{Δ t} 4 σ \qquad ( 3 )$$

Δμₐ^{R=1} represents the mobility resolution, i.e. the minimal difference in mobility required to be able to resolve two peaks (have a resolution of 1).

This can be further rearranged given that the average apparent mobility can be assumed equal to the apparent mobilities of the two analytes:

$$Δ μ = 4 σ \frac{{( {μ}_{analyte} + {μ}_{E O F} )}^{2} E}{{l}_{detection}} \\ Δμ \text{:} = Δ {μ}_{a}^{R = 1} \qquad ( 4 )$$

μ_{analyte}: analyte mobility

μ_{EOF}: mobility of the electro-osmotic flow

E: electric field

I_detection: length of the capillary from injection to detection.

In this way, mobility resolution represents the minimum mobility difference necessary to separate two very similar peaks (in our case, two identical peaks—which is the limiting case). Note that by using apparent electrophoretic mobility, no estimate of the electrophoretic mobility of fluorescein or EOF is necessary, as apparent mobility may be calculated directly from sample velocity: Uₛₐₘₚₗₑ=μₐ×E. Combined with the flow rate measurement, this may be used to estimate electrophoretic mobility of fluorescein in a given buffer. Furthermore, from calculated mobility resolution (which is the value obtained by setting R=1) and equation (2), one can calculate apparent mobility of analyte from peak capacity: μₐ=n×Δμₐ^{R=1}.

Finally, theoretical mobility resolution is defined in the same way as mobility resolution, but with sigma replaced by the expected peak width based on sample's diffusion:

$$Δ μ = 4 \sqrt{\frac{2 D}{V} ( {μ}_{analyte} + {μ}_{EOF} ) \frac{L}{{l}_{detection}}} \qquad ( 5 )$$

D: sample diffusion coefficient

V: applied voltage

L: total capillary length.

Depending on the significance of injection width, it may also be included in the calculation.

Various techniques may be used to inject the sample into a chip. For example, the sample can be injected into an inlet port of the chip using electrokinetic injection. It may be advantageous to provide electrokinetic injection because electrokinetic injection requires the use of electrodes which are already present in a typical CE set up. Thus, this may help to reduce manufacturing costs and saves time. Examples of electrokinetic separation techniques may include, but is not limited to, isotachophoresis, capillary zone electrophoresis.

In another example, pressure-driven or pneumatic techniques can be used for injecting samples into the chip. Pressure-driven injection may be advantageous because it is not biased with respect to sample mobility, i.e. one can inject all sample components equally.

The configuration for electrokinetic sample injection i.e. voltage applied may be the following: sample 0 kV; buffer −0.735 kV; sample waste −1.5 kV; buffer waste 0 kV.

The configuration for running at −10 kV may be the following: sample −0.4 kV; buffer 0 kV; sample waste −0.4 kV; buffer waste −10 kV.

At −10 kV: velocity can be varied during injection before the experiments. Flow rates of the separation and auxiliary fluids during sample injection and separation may be measured using an external flow sensor, such as a Sensirion LG16 0150D, max. 7000 nl/min. Referring to FIGS. 4A and 4B, there provided graphs showing the flow rates during injection for −10 kV series:

a) at the start of experimental series;

b) at the end of the experimental series. Flow took longer to stabilize at the start of experimental series.

It can take about 4 seconds to reach the stable flow rate of 137 nl/min; the initial overshoot is also larger. At the end of the series, time to reach a stable flow rate is more in the range of 1 second.

FIG. 5 shows the flow rate during an experiment with multiple cycles of injection and separation of a sample. The flow rate remained between 190-195 nl/min during the experiment (195-200 nl/min with an offset of 5 nl/min) as shown in FIG. 5. FIG. 5 shows the flow rate measured during acquisition.

### Example 1—H-filter Performance

In this example, the diffusion of components in the H-filter can be tested where there are no electrokinetic instabilities or other undesired effects. In addition, the diffusion coefficients for fluorescein, BSA and ovalbumin can be quantified thereby precisely and accurately determines their hydrodynamic radius.

In some instances, tracking a sample plug/stream running through the H-filter of PDMS prototype microfluidic chips by using video materials can be used to analyse and determine the diffusion coefficient of fluorescein, BSA and ovalbumin in Hepes buffer.

Setup

In some instances, the microfluidic chip design may comprise a symmetric H-filter design, meaning that the separation channel and auxiliary fluid inlet are of equal length. The channel dimensions within the chip may be 37 μm×25 μm. The H-filter channel dimensions may be 64 μm×25 μm. The chip may be made from polymer materials such as PDMS-PDMS or it may be made from glass or plastic. The chip may also be made from a combination of plastic and glass materials. In some embodiments, the chip may be made from PDMS bonded to glass. The chip may include an injection tip and tubing at a buffer waste port, connected to a flow sensor and a syringe.

Referring to FIG. 6, there is shown a combined electrophoresis-diffusive sizing chip 100 comprising a sample inlet port 102 configured to provide a sample fluid and an auxiliary inlet port 104 configured to provide a buffer solution. FIG. 6 shows the electrophoresis-diffusive sizing chip 100 with an H-filter 106 connected to the outlet ports 110. The detailed image shows the H-filter channel 108 with x and y coordinate directions marked. The y-direction is the direction in which bulk movement of the sample occurs within the H-filter 106. The lateral distribution is established via diffusion in x-direction. Diffusion in the y-direction may be masked by peak broadening effects of the sample such as thermal peak broadening.

Sample

Table 1 shows the buffer and sample solution used in Example 1.

Samples

| Sample | Concentration | pH | Solvent |
|---|---|---|---|
| Hepes 1× | 10 mM | 7.2 (measured) | dH₂0 |
| Fluorescein | 0.1 mM | | Hepes 1× |
| Alexa 488 | 0.5 mM | | Hepes 1× |
| Ovalbumin | | | |
| Label ratio: 7 to 8 | | | |
| FITC BSA | 0.5 mM | | Hepes 1× |
| (label ratio: >7) | | | |

Instrument

Illumination apparatus includes Thorlabs M490L4-470 nm LED at 900 mA. The objective may comprise a 10× Olympus. The camera may be a Hamamatsu Orca/orca Flash 4; Frame rate: 10 fps, binning 1×1, 100 ms exposure time. The instrument may also include a voltage source connectable to the electrodes. A typical voltage source could be a Spellman cze2000. The electrode may be inert.

The electrode may be made from platinum. It is preferable to provide platinum (Pt) electrodes because platinum is often the most inert material and have good biocompatibility. The electrodes may be made from 0.127 mm diameter Pt wire. Additionally or alternatively, the electrode can be made out of gold or silver. The flow sensor can be a Sensirion LG16-0150D, max. 7000 nl/min.

Method

For fluorescein, the sample was injected and then run at 10 kV across the separation channel. The velocity determination or evaluation can be based on correlating the intensity profiles over time with an iteratively refined kernel that resembles the peak profile. This can give more precise velocity estimation for the calculation of the diffusion coefficient D:

$$C ( x ) = {C}_{o f f} + \frac{{C}_{d i f f}}{2} [ 1 - erf ( \frac{x - {x}_{0}}{2 \sqrt{D t}} ) ] \\ with \\ t = \frac{y}{v} \qquad$$

Here, C(x) is the fluorescence intensity over the lateral position x, C_{off} is the intensity offset, C_{diff} is the intensity amplitude change, x₀ is the middle position of the channel where the original interface was, D is the diffusion coefficient and t the diffusion time determined from the y-position and the sample velocity v.

The fitting parameters are: C_{off}; C_{diff}; x₀ and D.

Least square fitting is applied on the intensity profile along the x-axis to determine all fitting parameters including diffusion coefficient D. The person skilled in the art will recognize that different fitting functions will be used depending on the channel cross section and flow profile.

Results

Fluorescein

The sample plug velocity is measured directly in the H-filter as shown in FIG. 7.

Referring to FIG. 7, there is shown velocity evaluation of the fluorescein plug inside the H-filter after 20 cm of separation channel driven at 10 kV. As shown in FIG. 7 there shown that over time, the sample plug corresponds to v=10.5 cm/min. As shown in FIG. 7, there is shown a profile shape of the sample plug. The sample velocity is: v=10.5 cm/s.

The intensity profile in x-direction is fitted for 64 locations along the y-axis. This is done for the frame that corresponds to the intensity maximum of the sample plug. Four fitting-examples are shown in FIGS. 8, 8B, 8C and 8D.

Referring to FIG. 8A to 8D, the intensity profile of fluorescein is across the x-position in width direction of the H-filter for different y-positions in channel direction. The measured data is indicated with a dashed line, and the fit function is indicated as a fine solid line. Diffusion levels out the intensities as the sample moves along the H-filter. Deviations from the expected profile can originate from the non-rectangular channel profile or inhomogeneities in the electro-osmotic flow profile.

The assumption “diffusion length<channel width” is violated for positions approximately y>400 um. This can be seen in the evaluation of the fitted diffusion coefficients as shown in FIG. 9.

Referring to FIG. 9, there is shown diffusion coefficient of fluorescein in Hepes buffer over position in H-filter channel direction. Three video frames corresponding to the maximum intensity of three consecutive sample plugs are evaluated. For locations<0.2 mm the diffusion coefficient is overestimated because of inlet effects. For locations>0.4 mm the diffusion coefficient is overestimated because the sample has diffused to the opposite channel wall. The measured diffusion coefficient is D=3×10⁻¹⁰ m²/s.

The time evaluation of the measured diffusion coefficient is shown in FIG. 10. Referring to FIG. 10, there is shown measured diffusion coefficient of fluorescein in Hepes buffer over time.

FIG. 10 shows that the degree of variance over the pass of the sample peak is reasonably low during times of high intensity.

Fluorescein-water:

$$D \approx 4.0 \cdot {10}^{- 10} \frac{{m}^{2}}{s} to 4.9 \cdot {10}^{- 10} \frac{{m}^{2}}{s}$$

This corresponds to an error of approximately 33-63% to the measured value of D=3×10⁻¹⁰ m 2/s. Deviations may stem from inaccuracies in the channel cross-section or the flow rate determination, as well as inhomogeneities of the channel's surface potential.

In case a peak is not fully resolved by the separation step, the measured diffusion profile will be linear combination of the two or more unresolved component. For example, to compensate the overlay of the two diffusion contours, here BSA and FITC, the fitting formula is adapted as follows:

$$C ( x ) = {C}_{o f f} + \frac{{C}_{diff\_BSA}}{2} [ 1 - erf ( \frac{x - {x}_{0}}{2 \sqrt{{D}_{B S A} {t}_{B S A}}} ) + \frac{{C}_{diff\_FITC}}{2} [ 1 - erf ( \frac{x - {x}_{0}}{2 \sqrt{{D}_{F I T C} {t}_{F I T C}}} ) ] \qquad$$

The first part represents the standard fitting equation and the second part corresponds to an overlaid diffusion of FITC with all parameters prescribed:

$${C}_{diff\_FITC} = 0.2 {C}_{diff\_BSA}$$

$${C}_{diff\_FITC} = 3 \cdot {10}^{- 10} m 2 / s$$

$${t}_{FITC} = \frac{y}{{v}_{FITC}}$$

This situation is emulated by running a continuous sample flow through the H-filter. In practice, this was done by constantly leaking sample into the separation channel—by increasing the voltage on the sample port during separation—and thus running a steady stream of sample mixture through the H-filter.

The intensity profile in x-direction is fitted for 64 locations along the y-axis. Four fitting-examples are shown in FIG. 11A, 11B, 11C and 11D.

FIGS. 11A, 11B, 11C and 11D illustrate the intensity profile of BSA across the x-position in width direction of the H-filter for different y-positions in channel direction. Diffusion levels out the intensities as the sample moves along the H-filter. Since the diffusion takes longer than for fluorescein, there is again no issue with sample reaching the opposite channel wall.

Referring to FIG. 12, there is shown diffusion coefficient of BSA in Hepes buffer over position along H-filter channel direction. For locations<0.2 mm the diffusion coefficient is overestimated because of entry effects. The measured diffusion coefficient is D=0.59×10⁻¹⁰ m²/s.

Calculation of Theoretical D

The molecular weight of BSA of 66.5 kDa corresponds to an approximate hydrodynamic radius of r=3.45 nm. The diffusion coefficient is given by the Stokes-Einstein equation:

$$D = \frac{{k}_{B} T}{6 π η r} = 0 .72 \cdot {10}^{- 10} {m}^{2} / s$$

Here, the Bolzmann constant is k_{B}=1.38·10⁻²³ , the dynamic viscosity of water is η=8.9·10⁻⁴Pa·s and the temperature is T=300 K. The difference of 22% to the measured value might partially be due to an over compensation for free FITC.

TABLE 2
Summary of results

| | | | Flow | Sample | Expected | Measured | |
|---|---|---|---|---|---|---|---|
| Sample | M | r_{hyd} | profile | velocity | D | D | Error |
| Fluorescein | 0.376 kDa | 0.5 nm | plug (FWHM = 3 mm) | 10.5 cm/min | $\begin{matrix}4.0 \cdot {10}^{- 10} \frac{{m}^{2}}{s} \\ to \\ 4.9 \cdot {10}^{- 10} \frac{{m}^{2}}{s}\end{matrix}$ | $3.0 \cdot {10}^{- 10} \frac{{m}^{2}}{s}$ | 33% to 63% |
| FITC BSA | 66.5 kDa | 3.45 nm | continuous | 6.6 cm/min (FITC comp.) | $0.72 \cdot {10}^{- 10} \frac{{m}^{2}}{s}$ | $0.59 \cdot {10}^{- 10} \frac{{m}^{2}}{s}$ (FITC comp.) | 22% |

Diffusion behaves as expected and the diffusion coefficients are quantitatively in line with expected values as demonstrated herein. Thus, the electroosmotically driven H-filter may be suited to measure the diffusion coefficient.

### Example 2—Characterisation of GFP-booster in Capillary Electrophoresis

GFP-booster sample comprises at least five species. In some cases, the species may comprise a different label. One of the aims is to characterise the behaviour of GFP-booster nanobody using capillary electrophoresis. Samples are tested in capillary electrophoresis experiments in glass chips.

Set Up

In some instances, the separation channel may comprise dimensions of 37 μm×10 μm. The material of the chip may be made from glass. Polymer materials such as PDMS pieces may be bonded on top of glass to interface with plastic pipette tips+tubing at buffer waste connected to flow sensors and a syringe.

Table 3 shows buffers and sample solution used in experiments described in Example 2.

| Sample | Product no. | Concentration | pH | Solvent |
|---|---|---|---|---|
| PBS | SRE0065 | 2 mM | 7.4 | dH₂O |
| GFP- | gba488-100 | 6.6 μM | | 2 mM |
| Booster | | | | PBS |

Instrument

Illumination apparatus includes Thorlabs M470L3-470 nm LED. The objective may comprise a 10× Olympus. The camera may be a Zyla sCMOS, model 5.5-USB3. The instrument may also include a voltage source connectable to the electrodes. The instrument may also include a voltage source connectable to the electrodes. A typical voltage source could be a Spellman cze2000. The electrode may be inert. The electrode may be made from platinum. It is preferable to provide platinum (Pt) electrodes because platinum is often the most inert material and have good biocompatibility. The electrodes may be made from 0.127 mm diameter Pt wire. Additionally or alternatively, the electrodes may be made from gold or silver. The flow sensor can be a Sensirion LG16-0150D, max. 7000 nl/min.

Baseline Separation

Multiple species have been detected in the sample as shown in FIGS. 13A and 13B. Sample separation into three peaks occurred already before 1 cm. At 2 cm another two or three peaks are resolved at very low intensity. Referring to FIGS. 13A and 13B, there are shown baseline peak separation series 1 and series 2. As shown in FIGS. 13C and 13D, three distinct peaks are visible at 1 cm; five peaks are visible from approximately 11 cm.

Peak Characterisation

Peaks that have been picked up by the video analysis software are characterised for their velocity. As shown in FIG. 14, data from four measurement series is merged into one so that the three distinct peaks with the highest intensities may be plotted, which are indicated as ‘slow’, ‘medium’ and ‘fast’ based on their relative velocities. The fastest peak is the one with the lowest intensity, which may be the reason for the largest error in its velocity determination. Video analysis code can also be improved so that low intensity peaks are also detected.

Diffusional Sizing

Characterisation of detected species can be possible with the use of an H-filter. The same procedure as outlined in the present invention can be used to evaluate the data and determine the diffusion coefficient and radius of detected species. Several consecutive injections are recorded, and as is visible from the FIG. 15, the medium peaks overtook the slow ones before reaching the H-filter. This means that the analysed peaks are most likely to stem from four different injections.

Peaks are recorded at the inlet of the H-filter, i.e. between 24 and 24.1 cm. Referring to FIGS. 16A and B, there is shown analysed frames for slow and medium speed peak, allowing the monitoring of the diffusive spreading as a function of distance from the entrance of the auxiliary fluid. Some entrance effects are expected at the point where sample mixes with the fresh buffer. Moreover, a small peak can be detected following the medium speed peak into the H-filter.

The surface charge in the H-filter may be non uniform, leading to irregular EOF.

GFP-booster can be characterized in HPC coated channel, but no diffusional sizing was possible. The experiments as described in herein and in particular, in Example 4 with the H-filter can be repeated with better-quality videos and more data at different positions along the H-filter. This can help improve estimation of the diffusion coefficient. Alternatively or additionally, different coatings or coating methods may be applied.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

1. A method of separating and analysing a plurality of components in a heterogeneous sample, the method comprising the steps of:
introducing a separation fluid into a separation channel that is elongate in a first direction;
introducing the heterogeneous sample into the separation channel;
separating, in the first direction, the components in the sample in the separation channel;
introducing the separation fluid and the heterogeneous sample from the separation channel and an auxiliary fluid from an auxiliary channel into a distribution channel;
creating a lateral distribution of the components in the distribution channel in a second direction substantially perpendicular to the first direction; and
determining, sequentially, a property of each of the components based on the regimen by which the lateral distribution was created.

2. The method according to claim 1, wherein the lateral distribution is created by diffusion and the property determined is the diffusion coefficient of the each of the components.

3. The method according to claim 1 any one of the preceding claims, wherein the lateral distribution is created electrophoretically through the application of an electric field in the second direction and the property determined is the electrophoretic mobility of each of the components.

4. The method according to claim 1, wherein the auxiliary fluid is the same as the separation fluid.

5. The method according to claim 1, wherein the auxiliary fluid has a different pH from the separation fluid.

6. The method according to claim 1, wherein the property determined is the isoelectric point of each of the components.

7. The method according to claim 1, wherein the separating of the components in the sample in the first direction is achieved using capillary electrophoresis through the application of an electric field in the first direction.

8. The method according to claim 1, further comprising the step of flowing a reference sample to verify the stability of the flow.

9. The method according to claim 1, further comprising determining the concentration of at least one of the components in the sample.

10. The method according to claim 1, wherein the force that generates the separation in the first direction is also responsible for the movement of the components through the distribution channel.

11. The method according to claim 1, wherein the flow velocity of the separation and/or the auxiliary fluids are measured by a flow sensor.

12. The method according to claim 1, wherein the time-dependent measurement of the property determined via analysing the distribution in the second direction is used to determine whether a peak from the separation in the first direction contains multiple species.

13. The method according to claim 1, wherein the step of separating, in the first direction, of the components in the sample takes place in free solution.

14. An apparatus for separating and analysing a plurality of components in a heterogeneous sample, the apparatus comprising:
a separation channel elongate in a first direction;
a distribution channel configured to enable a lateral distribution of the components to be formed in a second direction substantially perpendicular to the first direction according to a property of each of the components based on the regimen by which the lateral distribution was created; and
an electrode upstream of the separation channel and an electrode downstream of the distribution channel, configured to apply an electric field in the first direction.

15. The apparatus according to claim 14, wherein the distribution channel is a T-sensor.

16. The apparatus according to claim 14, wherein the distribution channel, together with the separation channel and an auxiliary channel, form an H-filter with extended inlets.

17. The apparatus according to claim 14, wherein the separation channel and the auxiliary channel are of equal length.

18. The apparatus according to claim 14, wherein the separation channel and the auxiliary channel are of equal cross sectional area.

19. The apparatus according to claim 14, wherein the distribution channel has a cross-sectional area that is the sum of the cross sections of the separation and auxiliary channels.

20. The apparatus according to claim 14, wherein the separation channel is co-linear with the distribution channel.

21. The apparatus according to claim 14, wherein the distribution channel has a width of less than 150 m.

22. The apparatus according to claim 14, wherein the distribution channel has a height that is less than its width.

23. The apparatus according to claim 14, further comprising flow sensors to determine the bulk flow rate.

24. The apparatus according to claim 14, further comprising a detection zone downstream of the distribution channel in which the amount of each of the separated components is quantified.

25. The apparatus according to claim 14, further comprising a labelling zone, downstream of the distribution channel and upstream of a detection zone in which one or more components are labelled.

26. The apparatus according to claim 14, where the separation and distribution channels are part of a disposable chip.
